(19) United States
(12) Patent Application Publication
(10) Pub. No.: US 2011/0282897 A1
(43) Pub. Date: Nov. 17, 2011

(54) METHOD AND SYSTEM FOR MAINTAINING A DATABASE OF REFERENCE IMAGES

(75) Inventors: Yiqun Li, Singapore (SG); Joo Hwee Lim, Singapore (SG); Hanlin Goh, Singapore (SG)

(73) Assignee: Agency for Science, Technology and Research, Connexis (SG)

(21) Appl. No.: 12/996,494

(22) PCT Filed: Jun. 5, 2009
(86) PCT No.: PCT/SG2009/000198

§ 371 Date: Aug. 3, 2011

Related U.S. Application Data
(62) Division of application No. 61/059,331, filed on Jun. 6, 2008.

(51) Int. Cl. G06F 17/30

(52) U.S. Cl. 707/769; 707/E17.03

(57) ABSTRACT

A method and system for maintaining a database of reference images, the database including a plurality of sets of images, each set associated with one location or object. The method comprises the steps of identifying local features of each set of images; determining distances between each local feature of each set and the local features of all other sets; identifying discriminative features of each set of images by removing local features based on the determined distances; and storing the discriminative features of each set of images.

### FIELD OF INVENTION

The present invention broadly relates to a method and system for maintaining a database of reference images, to a method and system for image based mobile information retrieval, to a data storage medium comprising code means for instructing a computing device to exercise a method of maintaining a database of reference images, and to a data storage medium comprising code means for instructing a computing device to exercise a method for image based mobile information retrieval.

### BACKGROUND

As mobile phones are becoming increasingly widespread, delivering personalized services to a mobile phone is emerging as an important growth area. Providing location-specific information is one such service. Examples of location-specific information include name of the place, weather at the place, nearby transports, hotels, restaurants, bank/ATM, shopping centres and entertainment facilities etc.

One of the steps in providing location-specific information comprises recognising the location itself. This can be done in several ways. However, the conventional methods for location recognition have many limitations, as described below.

In one existing technology, Global Positioning System (GPS) device-based and wireless network system-based methods are used to measure the precise location of a spot. Location recognition using a GPS-enabled mobile phone is understood in the art and will not be discussed herein. Location recognition based on a wireless network system typically relies on various means of triangulation of the cellular signal at mobile base stations for calculating the position of the mobile device.

However, the above location determination methods have problems in accuracy and recognition speed. Further, they may not be used in environments including a shadow area where a signal may not reach due to frequency interference or reduction of signal strength, and an indoor area or a basement that e.g. a GPS signal may not reach. They also depend on the availability of such device and network system.

Another existing method comprises image-based location recognition that depends on an artificial or non-artificial landmark, indoor environment and other conditions. For example, in robot navigation, topological adjacency maps or the robot's moving sequence or path is used to assist the calculation of the current location of the robot.

Another existing method comprises context-based place classification/categorization to categorize different types of places such as office, kitchen, street, corridor etc. However, this method relies on the context or objects appearing at the location.

Another existing method comprises web-based place recognition and information retrieval. In this method, an image taken by a camera is used to get a best-match image in the web. The system then looks for information about the place from the web text associated with the image. However, this method is highly dependent on the availability of the information on the web. Further, the information may be irrelevant to the place and there may not be a correct match. Thus, there can be reliability problems.

A need therefore exists to provide a method and system that seek to address at least one of the above problems.

### SUMMARY

In accordance with a first aspect of the present invention, there is provided a method of maintaining a database of reference images, the database including a plurality of sets of images, each set associated with one location or object; the method comprising the steps of:

identifying local features of each set of images;

determining distances between each local feature of each set and the local features of all other sets;

identifying discriminative features of each set of images by removing local features based on the determined distances; and

storing the discriminative features of each set of images.

The identifying of the local features may comprise:

identifying key points; and

extracting features from the key points.

The method may further comprise reducing a number of key points prior to extracting the features.

The reducing of the number of key points may comprise a region-based key point reduction.

The region-based key point reduction may comprise choosing one of the key points in a region having a highest radius.

The method may further comprise reducing a number of extracted features.

The reducing of the number of extracted features may comprise a hierarchical feature clustering.

The removing of local features based on the determined distances may comprise removing the local features having distances to any local feature of the other sets lower than a first threshold.

The removing of local features based on the determined distances may comprise:

calculating respective discriminative values for each local feature of said set based on the determined distances; and

removing the local features having discriminative values lower than a second threshold.

In accordance with a second aspect of the present invention, there is provided a method for image based mobile information retrieval, the method comprising the steps of:

maintaining a dedicated database of reference images as defined in the first aspect;

taking a query image of a location or object by a user using a mobile device;

transmitting the query image to a information server;

comparing the query image with reference images in the dedicated database coupled to the information server;

identifying the location or object based on a matched reference image; and

transmitting information based on the identified location or object to the user.

The comparing of the query image with reference images may comprise a nearest neighbour matching.

The nearest neighbour matching may comprise:

determining a minimum distance between each feature vector of the query image and feature vectors of reference images of each location or object; and

calculating a number of matches for each location or object,

wherein a match comprises the minimum distance being smaller than a third threshold.

The third threshold may be equal to the first threshold.

The method may further comprise calculating a vote based on the number of matches and an average matching distance, wherein the highest vote comprises the nearest neighbour.

The identifying of the location or object may comprise a multi query user verification.

The method may further comprise transmitting a sample photo of the identified location or object to the user.

The multi query user verification may comprise taking a new query image of the location or object by the user using the mobile device and transmitting the new query image to an information server.

The method may further comprise calculating a confidence level of the identified location or object based on results of one or more previous query images and the new query image.

The method may further comprise transmitting a new query image recommendation to the user if the confidence level of the identified location or object is below a fourth threshold.

In accordance with a third aspect of the present invention, there is provided a system for maintaining a database of reference images, the database including a plurality of sets of images, each set associated with one location or object; the system comprising:

means for identifying local features of each set of images;

means for determining distances between each local feature of each set and the local features of all other sets;

means for identifying discriminative features of each set of images by removing local features based on the determined distances; and

means for storing the discriminative features of each set of images.

The means for identifying the discriminative features may remove the local features having distances to any local feature of the other sets lower than a first threshold.

The means for identifying the discriminative features may calculate respective discriminative values for each local feature of said set based on the determined distances, and remove the local features having discriminative values lower than a second threshold.

In accordance with a fourth aspect of the present invention, there is provided a data storage medium comprising code means for instructing a computing device to exercise a method of maintaining a database of reference images, the database including a plurality of sets of images, each set associated with one location or object; the method comprising the steps of:

identifying local features of each set of images;

determining distances between each local feature of each set and the local features of all other sets;

identifying discriminative features of each set of images by removing local features based on the determined distances; and

storing the discriminative features of each set of images.

In accordance with a fifth aspect of the present invention, there is provided a system for image based mobile information retrieval, the system comprising:

means for maintaining a dedicated database of reference images as defined in the first aspect;

means for receiving a query image of a location or object taken by a user using a mobile device;

means for comparing the image with reference images in the dedicated database;

means for identifying the location or object based on a matched reference image; and

means for transmitting information based on the identified location or object to the user.

In accordance with a sixth aspect of the present invention, there is provided a data storage medium comprising code means for instructing a computing device to exercise a method for image based mobile information retrieval, the method comprising the steps of:

receiving a query image of a location or object taken by a user using a mobile device;

comparing the image with reference images in the dedicated database;

identifying the location or object based on a matched reference image; and

transmitting information based on the identified location or object to the user.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a block diagram illustrating a system for providing information based on location recognition according to an example embodiment.

FIG. 2 shows a flowchart illustrating a process for learning characteristics of a location according to an example embodiment.

FIG. 3 shows a schematic diagram illustrating how viewer-centric sample images are collected according to an example embodiment

FIG. 4 shows a schematic diagram illustrating how object-centric sample images are collected according to an example embodiment.

FIGS. 5A and 5B show two adjacent images of a location. FIG. 5C shows an image a panoramic image formed by combining the images of FIGS. 5A and 5B according to an example embodiment.

FIG. 6A shows a sample image and respective key points detected thereon. FIG. 6B shows the sample image of FIG. 6A and respective key points after a region-based key point reduction according to an example embodiment.

FIG. 7 shows a flowchart illustrating a method for region-based key point reduction according to an example embodiment.

FIG. 8 shows blocks which are used to calculate a color-edge histogram according to an example embodiment.

FIG. 9 shows overlapping slices in a circular region for an average color calculation of an LCF feature according to an example embodiment.

FIGS. 10A and 10B show two separate images on which respective feature vectors detected are clustered into one cluster according to an example embodiment.

FIG. 11 shows graphs comparing respective distributions of Inter-class Feature Distance (InterFD) and Intra-class Feature Distance (IntraFD) before features with lower InterFD are removed according to an example embodiment.

FIG. 12 shows graphs comparing respective distributions of Inter-class Feature Distance (InterFD) and Intra-class Feature Distance (IntraFD) after features with lower InterFD are removed according to an example embodiment.

FIG. 13 shows graphs and of FIGS. 11 and 12 respectively comparing distributions of Inter-class Feature Distance (InterFD) before and after a discriminative feature selection according to an example embodiment

FIG. 14 shows discriminative features on two different images according to an example embodiment.

FIG. 15 shows a graph of the distribution of true positive test images against the nearest matching distance and a graph of the distribution of false positive test images against the nearest matching distance according to an example embodiment.

FIG. 16 shows graphs comparing the number of feature vectors before and after each reduction according to an example embodiment.

FIG. 17 shows a chart comparing recognition rate without verification scheme and recognition rate with verification scheme according to an example embodiment.

FIG. 18 shows a flowchart illustrating a method for maintaining a database of reference images according to an example embodiment.

FIG. 19 shows a schematic diagram of a computer system for implementing the method of an example embodiment.

FIG. 20 shows a schematic diagram of a wireless device for implementing the method of an example embodiment.

### DETAILED DESCRIPTION

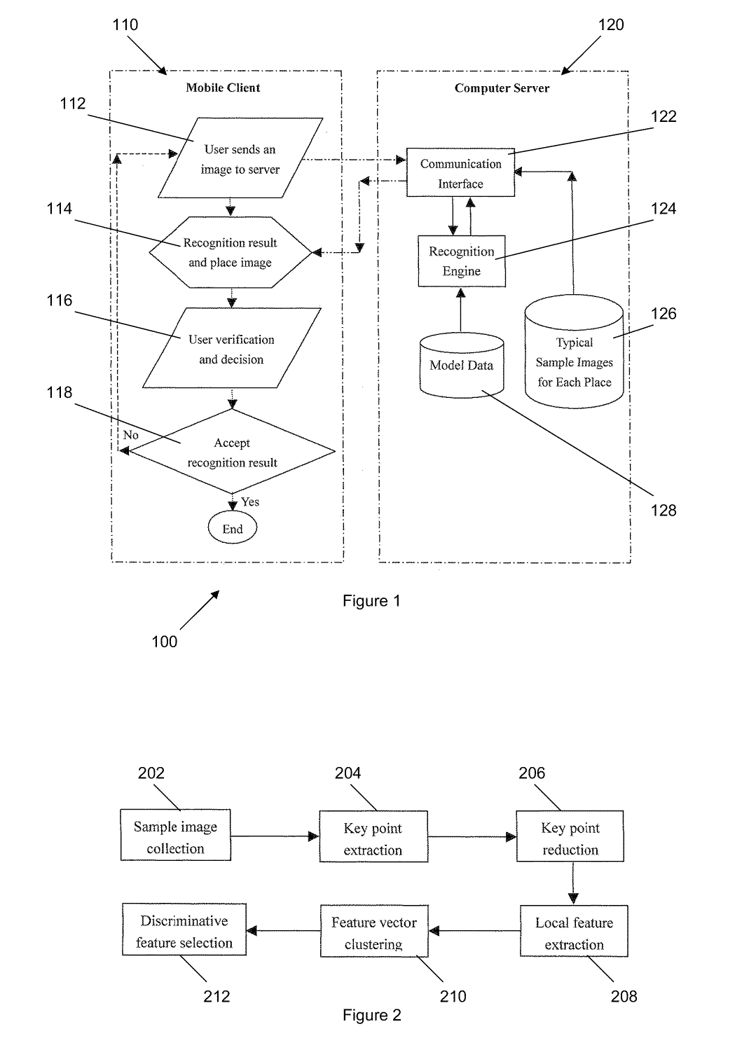

FIG. 1 shows a block diagram 100 illustrating a system and process for providing information based on location recognition according to an example embodiment. The system comprises a mobile client 110 and a computer server 120. The mobile client 110 is installed in a wireless device, e.g. a mobile phone, in a manner understood by one skilled in the relevant art. The computer server 120 is typically a computer system. The mobile client 110 may communicate directly with the computer server 120, or via an intermediary network, e.g. a GSM network (not shown).

On the mobile client 110, the user takes a photo at a location using the mobile phone camera and sends the photo to the server 120 at step 112. The server 120 comprises a communication interface 122, a recognition engine 124, a database 126 of typical images for each place and model data 128. The server 120 receives the photo via the communication interface 122 and sends the photo to the recognition engine 124 for processing. The recognition engine 124 locates where the image is taken based on model data 128 and returns relevant information 114 about the place as a recognition result to the user via the communication interface 122 in the example embodiment.

The relevant information 114, e.g. name of the place, weather at the place, nearby transports, hotels, restaurants, bank/ATM, shopping centres and entertainment facilities etc., is prior constructed and stored in the server 120 in the example embodiment. The relevant information 114 also comprises a typical image of the recognized place obtainable from the database 126 in the example embodiment. At step 116, the user verifies the recognition result e.g. by visually matching the returned typical image of the recognized place with the scenery of the place where he is. If the recognition result is not accepted at 118, the user can send another query image to the server 120 to improve the recognition accuracy and the reliability of the result. This can ensure quick and reliable place recognition and thus accurate information retrieval can be achieved.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

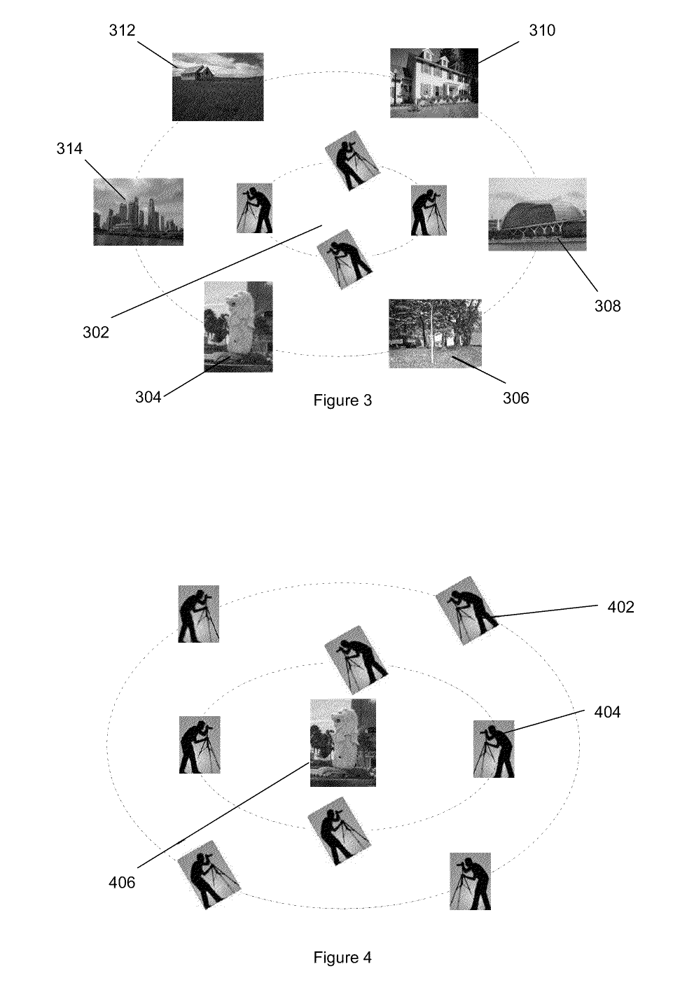

FIG. 2 shows a flowchart illustrating a process for learning characteristics of a location according to an example embodiment. At step 202, sample images (i.e. training images) are collected. This can be done based on a viewer-centric or object-centric method, depending on whether viewer location or object location recognition is desired, respectively. For the viewer-centric dataset, sample images are stitched in the example embodiment if there are overlapping regions. At step 204, key points on every image are extracted. At step 206, the key points are reduced based on e.g. a region-based key point reduction method. At step 208, a local feature is extracted on each key point. At step 210, feature vectors on the images of each place are clustered. At step 212, discriminative feature vectors are selected as model data 126 (FIG. 1) of the location, and stored in the server 120 (FIG. 1) for the recognition engine 124 (FIG. 1) to use.

Sample Image Collection

FIG. 3 shows a schematic diagram illustrating how viewer-centric sample images are collected according to an example embodiment. The sample images are taken at different positions within certain distance to a specific geographic location 302 towards surrounding scenes 304, 306, 308, 310, 312, 314, etc. The more representative and complete sample images are collected for each place, the better recognition accuracy can be achieved. For example, in a prototype based on the system of the example embodiment, 25 sample images are collected per place for 50 places for the viewer-centric dataset.

FIG. 4 shows a schematic diagram illustrating how object-centric sample images are collected according to an example embodiment. The sample images are taken from different angles and distances 402, 404, etc. towards an object 406. The images are preferably taken at popular areas accessible by visitors towards distinctive or special objects which are different from those at other places. All representative objects are preferably included in the sample dataset in order to have a complete representation of the place. For example, for the object-centric dataset in a prototype based on the system of the example embodiment, 3040 images are collected with different number of images per place for a total of 101 places.

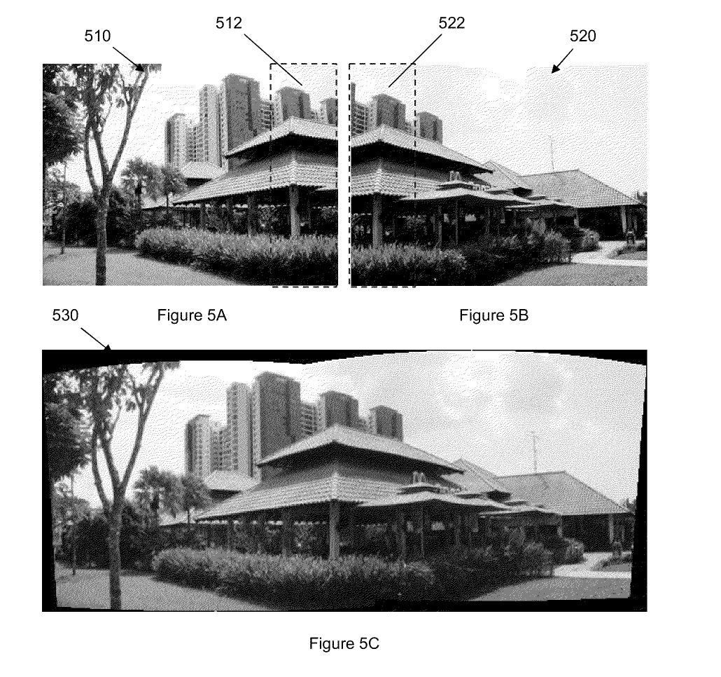

FIGS. 5A and 5B show two adjacent images 510 and 520 of a location. FIG. 5C shows a panoramic image 530 formed by combining the images 510 and 520 of FIGS. 5A and 5B according to an example embodiment. As seen in FIGS. 5A-C, region 512 of FIG. 5A overlaps with region 522 of FIG. 5B. In the example embodiment, sample images 510 and 520 are combined, e.g. by image stitching, to form a synthesized panoramic image 530 such that overlapping regions, e.g. 512, 522, among different sample images are reduced. Occlusions may also be removed after image stitching. The new panoramic images are used instead of the original sample images to extract features to represent the characteristics of the location.

Key Point Extraction

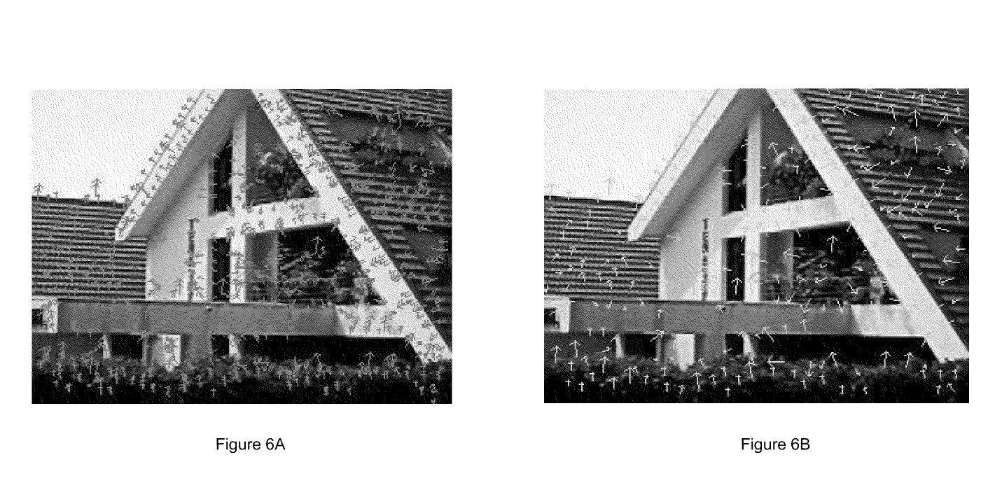

FIG. 6A shows a sample image and respective key points detected thereon. FIG. 6B shows the sample image of FIG. 6A and respective key points after a region-based key point reduction according to an example embodiment. The key points on the image of FIG. 6A can be calculated in an example embodiment based on a method described in David G. Lowe. “Object Recognition from Local Scale-Invariant Features”, Proc. of the International Conference on Computer Vision, Corfu, Greece, September 1999. pp. 1150-1157, the contents of which are hereby incorporated by cross reference. In summary, the following steps are produced:
1. For a given image colour channel, a Gaussian pyramid is built, where the differences between the standard deviation of the Gaussians for the different levels are about square root of 2.
2. The Differences of Gaussians (DoG) between the levels of the pyramid are computed.
3. The local maxima of each level are computed. If their values are greater than the given threshold multiplied by the maximum value in the image, then consider that region as a valid interesting region and insert it in the regions list.
4. For each region in the list, its orientation is computed using the maximal value in an orientation histogram computed for a window of the size given in the parameters.

In the example embodiment, by using the above method with a default Saliency Threshold of value 0.0, the number of key points detected in an image in a dataset ranges from about 300 to 2500.

Key Point Reduction

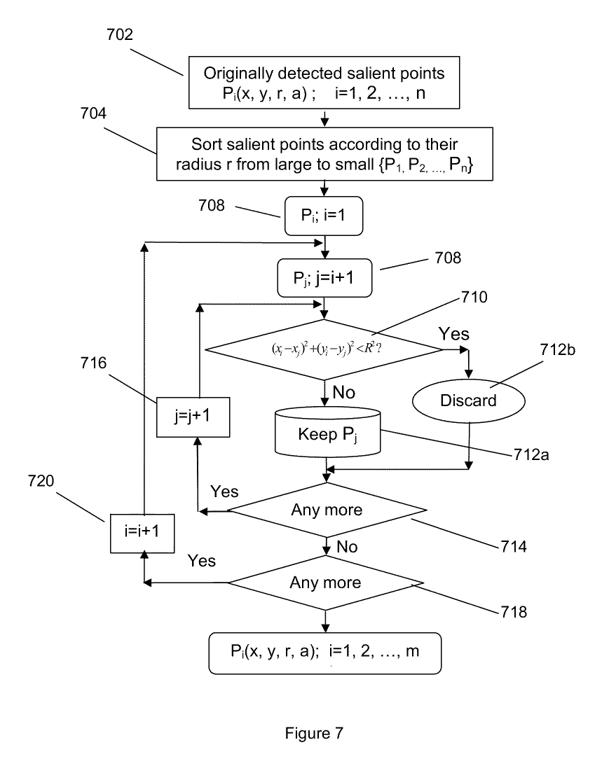

FIG. 7 shows a flowchart illustrating a method for region-based key point reduction according to an example embodiment. At step 702, a number of salient points Pᵢ (x, y, r, a) (where i=1, 2, . . . , n; r is the radius and a is the angle for the Scale Invariant Feature Transform (SIFT) feature at key point (x, y)) are detected in a region, based on the method as described above. At step 704, the salient points are sorted according to their radius from the largest to the smallest, i.e. {P₁, P₂, . . . , Pₙ}. At step 706, a first point Pᵢ is initialized as the point with the largest radius, i.e. P₁. At step 708, a second point Pⱼ is initialized as the point with the next largest radius, i.e. j=i+1. At step 710, the square of a distance between the first point Pᵢ and the second point Pⱼ is calculated and compared against the square of a threshold R.

If the distance is larger than the threshold R, the second key point Pⱼ is kept (Step 712a). Otherwise, the second key point Pⱼ is discarded (Step 712b). That is, from the second key point to the last key point in the list (Pⱼ=P₂ to Pₙ), if the distance between any one of these points and the first point P₁ is less than the threshold R, the key point is removed from the list.

At step 714, the system checks whether there are more key points in the sorted salient points list. If the result is yes, at step 716, steps 710 to 714 are repeated until all salient points in the sorted salient points list have been tested. If the result is no, at step 718, the system checks whether there are remaining points in the sorted list. If there are, at step 720, steps 708 to 718 are repeated using the next remaining point as Pᵢ until all the remaining key points in the list are examined. If there is no other point in the sorted list to use as Pᵢ, a reduced number of points Pᵢ (x, y, r, a) (where i=1, 2, . . . , m and m≦n) is returned.

At the end, there will not be more than one key point in any region with R² round area. In other word, there is only one key point with the largest radius r left in any R² round region if there are more one key points existing in that region initially. Eventually, the key points are more evenly distributed on the image. The remaining number of key points m will be less than the initial number of key point n. The region-based key point reduction method of the example embodiment can also significantly reduce the key points without degrading the recognition accuracy. In experiments using the system of the example embodiment, after region-based feature reduction, the number of key points is reduced by almost half and thus the number of features to represent the image is reduced by almost half. Experimental results have shown that after this feature reduction, the recognition accuracy is not substantially affected.

Local Feature Extraction

For viewer location recognition using viewer-centric sample images, in the example embodiment, Scale Invariant Feature Transfer (SIFT) is used as the local feature for every selected key point. SIFT is computed based on the histograms of the gradient orientation for several parts of the region delimited by a location, where the weights of each sample are determined by the magnitude of the gradient and the distance to the center of the location. In the example embodiment, the location is divided in each axis by e.g. a given integer number h, which results in a total of h×h histograms and each one of them having n×n samples, where n represents the sample region size.

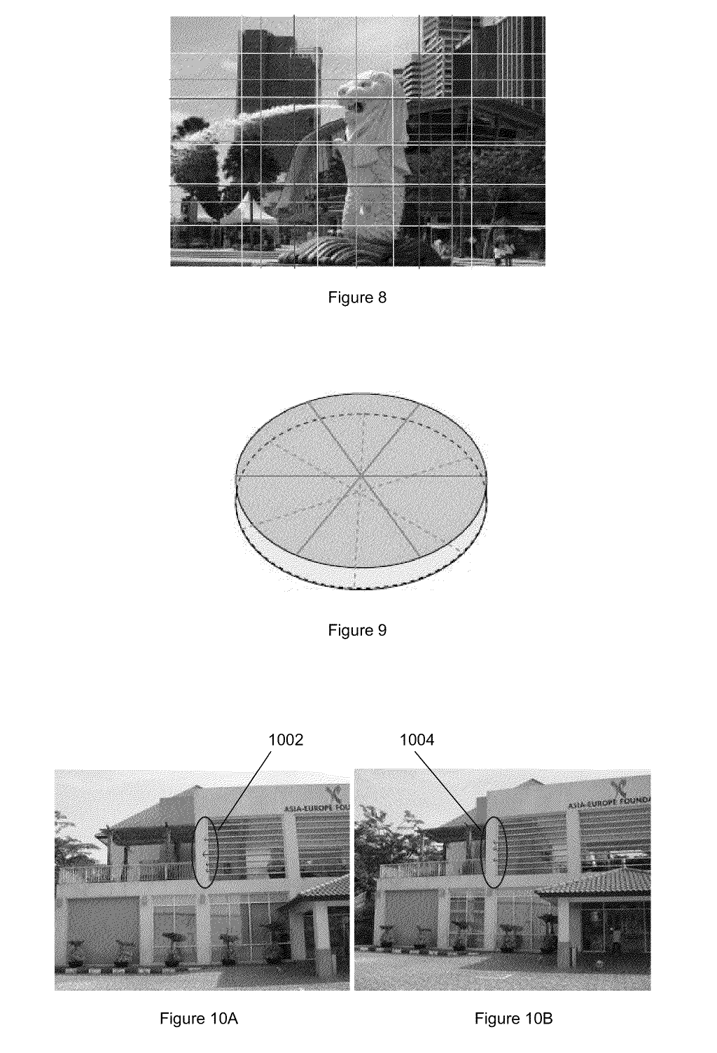

For object location recognition using object-centric sample images, in an example embodiment, multi-scale block histograms (MBH) are used to represent the features of the location. FIG. 8 shows blocks which are used to calculate a color-edge histogram according to an example embodiment. As seen from FIG. 8, each group of lines represents one size of the block. In the example embodiment, different sizes of the blocks with position shift are used to calculate the color-edge histograms. The color-edge histograms are calculated for each block to form a concatenated feature vector. The number of feature vectors depends on the number of blocks.

It should be appreciated that any color space such as Red-Green-Blue (RGB), hue-saturation-value (HSV), hue-saturation (HS), etc can be used. In the system of the example embodiment, the HSV color space is used. The color histograms C(i) are the concatenation of histograms calculated on the three channels of the HSV color space, i.e.:

C(i)={H(i),S(i),V(i)} (1)

The edge histograms E(i) are the concatenation of histograms of the Sobel edge magnitude (M) and orientation (O).

E(i)={M(i),O(i)} (2)

The MBH in the example embodiment is a weighted concatenation of color and edge histograms calculated on one block, which forms one feature vector for the image, where a and b are parameters less than 1.

MBH(i)={aC(i),bE(i)} (3)

In an alternate embodiment, Local Color Feature (LCF) and Local Color Histogram (LCH) are used to represent the features of the location. LCF is the color feature in a circular region around the key point. The region is divided into a specified number of slices with the feature as the average color for each slice and its overlapping slices. FIG. 9 shows overlapping slices in a circular region for an average color calculation of an LCF feature according to an example embodiment. As illustrated in FIG. 9, when 6 slices is used, for example, the LCF feature has 36 dimensions, i.e.

LCF(i)={R₁(i),G₁(i),B₁(i), . . . ,R₁₂(i),G₁₂(i),B₁₂(i)} (4)

In the example embodiment, LCH is the color histogram in a circular region around the key point, i.e.

LCH(i)={H(i),S(i),V(i)} (5)

Feature Vector Clustering FIGS. 10A and 10B show two separate images on which respective feature vectors detected are clustered into one cluster according to an example embodiment. After the region-based feature reduction as described above, the number of feature vectors in an image may still be too large. In the example embodiment, a hierarchical clustering algorithm is adopted to group some of the similar features into one to further reduce the number of feature vectors. For example, similar feature vectors 1002 and 1004 on FIGS. 10A and 10B respectively are grouped into one cluster in the example embodiment. The clustering algorithm works by iteratively merging smaller clusters into bigger ones. It starts with one data point per cluster. Then it looks for the smallest Euclidean distance between any two clusters and merges those two clusters with the smallest distance into one cluster. For an example of a clustering algorithm suitable for use in the example embodiment, reference is made to http://home.dei.polimi.it/matteucc/Clustering/tutorial_html/hierarchical.html, the contents of which are hereby incorporated by cross reference. In the example embodiment, the merging is only repeated until a termination condition is satisfied. In the example embodiment, the distance d[(r), (s)] between two pair of nearest clusters (r), (s) is used as the termination condition.

d[(r),(s)]=min{d[(i),(j)]} (6)

where i, j are all clusters in the current clustering.

The distance is calculated in the example embodiment according to average-linkage clustering method, and is equal to the average distance from any member of one cluster to any member of the other cluster.

In the example embodiment, a set of test images is first classified into different classes of sample images without clustering to get a first classification result. For example, one class of sample images is collected at one location and is used to represent that location, and a Nearest Neighbour Matching approach is used for classification. By referring to the distance between the test image and the correct matching sample image, an initial termination distance D to terminate the clustering algorithm is obtained in the example embodiment. The number of feature vectors then becomes the number of clusters. The centroid of the cluster C ε{cᵢ=i, 2, . . . , m} (where m is the dimension of the feature vector) is used as a new feature vector to represent the cluster of feature vectors, i.e.

$${c}_{i} = \frac{1}{n} {\sum }_{j = 1}^{n} {f}_{ij} \qquad ( 7 )$$

where fᵢⱼ (i=1, 2, . . . , m) is the original feature vector in the cluster, and n is the number of feature vectors in that cluster.

With the newly formed feature vectors to represent the sample images, the test images are classified again into different classes of sample images in the example embodiment. The classification result is compared with the previous classification result. Depending on the difference of this classification result ΔR, the clustering is conducted again with the termination distance D adjusted to D+ΔD. The whole process is repeated till the best classification result is achieved and thus the final termination distance and number of clusters are determined.

Based on the above termination condition, the clustering algorithm according to the example embodiment can advantageously reduce the number of clusters while preventing the clusters from continuously merging until only one cluster remains.

Discriminative Feature Selection

For object recognition or categorization, a discriminative feature can be derived from inter-class dissimilarity in shape, color or texture. However, for images taken at any outdoor location, there may not be any definite object with consistent shape, color and texture at a specific location. The content in the images representing the location could exhibit clutter with transient occlusion. There may also be similar objects or features on the images captured from different locations. When the locations are modelled using all the features, similar objects or features across different locations may confuse the classifier when a query is being presented to the system.

In the example embodiment, to investigate the similarity and dissimilarity of intra-class and inter-class features, a City Block Distance is used to evaluate the similarity of two feature vectors. The definition of the City Block Distance (D) between point P₁ with coordinates (x₁, y₁) and point P₂ at (x₂, y₂) in the example embodiment is

D=|x₁−x₂|+|y₂−y₂| (8)

Based on the training images collected at all relevant locations, the features, e.g. MBH features, are extracted on all the images collected at each location in the example embodiment. In addition, as the distance between two feature vectors is used to measure the similarity between said two feature vectors, said two feature vectors are considered discriminative if the distance between them is large enough. In the example embodiment, a validation dataset collected at different locations is used to evaluate the discriminative power of the feature vectors extracted on the training images.

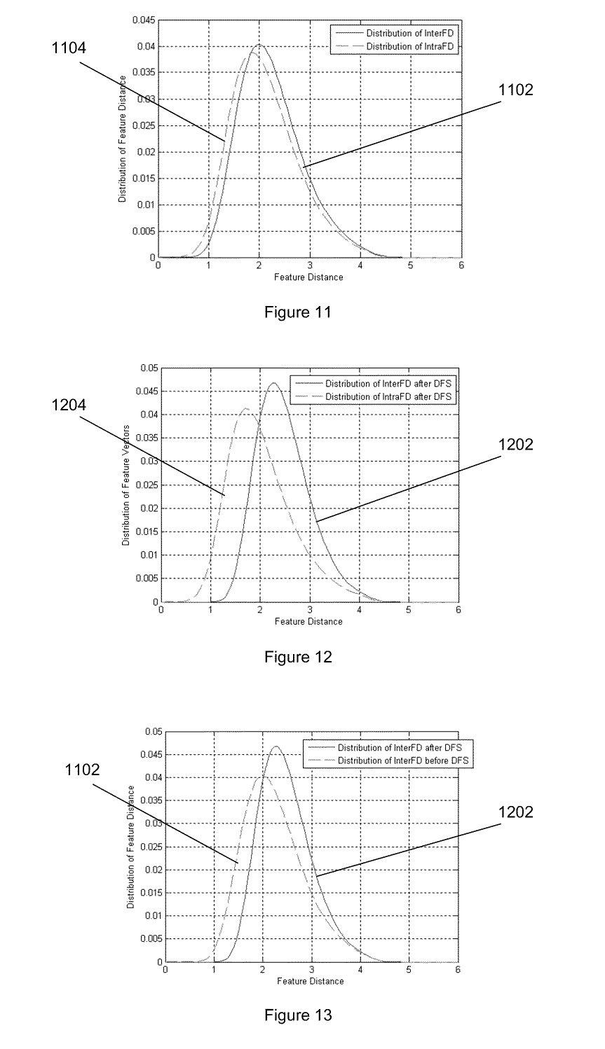

FIG. 11 shows graphs 1102 and 1104 comparing respective distributions of Inter-class Feature Distance (InterFD) and Intra-class Feature Distance (IntraFD) before a feature vectors with lower InterFD are removed according to an example embodiment. The InterFD is calculated between the training images at each location and the validation images collected at all other different locations. The IntraFD is calculated between the training images at each location and the validation images collected at the same location as where the training images are.

InterFD=|fᵥ(i,j)−fₜ(k,l)| j≠l (9)

IntraFD=|fᵥ(i,j)−fₜ(k,l)| j=l (10)

where fᵥ(i, j) is the i^{th} feature vector extracted on the validation images captured at location j. fₜ(k, l) is the k^{th} feature vector extracted on the training images captured at location l.

As can be seen from FIG. 11, there are a lot of overlaps between the InterFD and IntraFD. Many InterFD are smaller than IntraFD, which means that the InterFD and IntraFD cannot be well separated since there is not clear boundary between the InterFD and IntraFD and thus the task of discrimination across different locations is not trivial.

In addition to class separability, another critical issue is that too many feature vectors are extracted from each class, causing relatively long computation time. In order to solve both of these problems, the method and system of the example embodiment seek to not only maximize the inter-class separability, but also to reduce the number of feature vectors. To shorten the computation time and also improve the separability, the method and system of the example embodiment do not seek to transform the original data to a different space, as carried out in existing methods, but try to remove the feature vectors in their original space according to some criteria so that the remaining data become more discriminative.

From the distributions of the InterFD and IntraFD, the inventors have recognised that if the feature vectors with lower InterFD are removed, features representing different locations can be more distinctive. With the similar inter-class feature vectors removed, the number of feature vectors representing the location can be reduced and the separability of different classes can be improved.

In the example embodiment, for any feature vector at location j, if the calculated City Block Distance is below a threshold, T:

|fₜ(i,j)−fᵥ(k,l)|<T j≠l (11)

then, fₜ(i, j) is removed from the original feature vectors extracted for location j. T is determined by the number of selected feature vectors and by ensuring the best possible recognition accuracy for a validation dataset.

FIG. 12 shows graphs 1202 and 1204 comparing respective distributions of Inter-class Feature Distance (InterFD) and Intra-class Feature Distance (IntraFD) after features with lower InterFD are removed according to an example embodiment. As illustrated in FIG. 12, the distributions of InterFD and IntraFD move apart from each other compared with FIG. 11. Most of the inter-class distances become larger and the intra-class distances become smaller. Thus, the InterFD and IntraFD are becoming more separable in the example embodiment.

FIG. 13 shows graphs 1102 and 1202 of FIGS. 11 and 12 respectively comparing distributions of Inter-class Feature Distance (InterFD) before and after a discriminative feature selection according to an example embodiment. As shown in FIG. 13, after the discriminative feature selection as described above, the distribution of InterFD moves to the right side with larger feature distance. As a result, the number of feature vectors with smaller InterFD is reduced in the example embodiment.

In an alternative embodiment, the features are selected based on a discriminative value, as described below.

It should be noted that in each of the sample images, a lot of features are detected. In the example embodiment, if the features only appear in images of one class and not in images of other classes, these features are assigned high discriminative values. Assuming that the features detected in all the sample images for class I is P_{I}={p_{I1}, p_{I2}, . . . . , p_{IM}} and the features detected in all the sample images of all the other classes except class I is P_{L}={P_{L1}, P_{L2}, . . . , P_{LN}}, the discriminative value L_{Ik} of feature k (pₖεP_{I}) in class I is formulated in the example embodiment using the following equation:

$${L}_{lk} = ( \frac{1}{M} {\sum }_{i = 1}^{M} {e}^{- \frac{1}{2} {D}_{ki}^{2}} ) / ( \frac{1}{N} {\sum }_{j = 1}^{N} {e}^{- \frac{1}{2} {D}_{kj}^{2}} ) . \qquad ( 12 )$$

where Dₖⱼ is the distance between feature k (pₖεP_{I}) and feature j(pⱼεP_{L}). Dₖᵢ is the distance between feature k and feature pᵢ(pᵢεP_{I}). The numerator and denominator of Equation (12) estimate the likelihood of the feature being generated by images of class I and L respectively.

Further, in the example embodiment, the distance Dᵢⱼ between any features i and j is calculated using the City Block Distance, as defined by the following equation:

$${D}_{ij} = {\sum }_{k = 1}^{n} \vert {x}_{ik} - {x}_{jk} \vert \qquad ( 13 )$$

where is the xᵢₖ value of feature vector i, and xⱼₖ is the k^{th} value of feature vector j.

After the discriminative value for every feature is calculated, all the features of images for each class of images are sorted according to their respective discriminative values and only a percentage of features with discriminative values higher than a threshold are selected as distinctive local features of the sample images for that location.

FIG. 14 shows discriminative features on two different images according to an example embodiment. It can be seen from FIG. 14 that the number of discriminative features (as represented by boxes 1402) is significantly fewer than the number of original features (as represented by arrows 1404).

Similar to the sample images, only a portion of the features detected on a test image is discriminative. Thus, these discriminative features should be used to compare with those of the sample images. In the example embodiment, to select the discriminative features for the test image, the distance from a feature on the test image to the discriminative features on the sample images is compared with the maximum distance between any discriminative features of a class of sample images.

The maximum distance between any two discriminative features in the I^{th} class of sample images is,

D_{I}=Max{Dᵢⱼ} where i=1,2, . . . ,M; j=1,2, . . . ,M (14)

where Dᵢⱼ is the distance between any two discriminative features pᵢ(pᵢεP_{I}) and pⱼ (Pⱼεp_{I}) in the I^{th} class of sample images and D_{I} is the maximum value among all Dᵢⱼ.

Assuming Dₜᵢ is the distance between a feature pₜ on a test image and a discriminative feature pᵢ on the sample images of the I^{th}. In the example embodiment, if, for any i from 1 to M, Dₜᵢ<D_{I} (i=1, 2, . . . , M), the feature pₜ in the test image is selected as a discriminative feature when it is used to match with the I^{th} class of sample images.

On the other hand, if, for any one of the discriminative feature pᵢ in the sample images of the I^{th} class, Dₜᵢ>D_{I} (i=1, 2, . . . , M), the feature pₜ in the test image is discarded in the example embodiment.

Based on the feature selection method for the test images described above, the number of features for the test image is advantageously reduced and false classification is reduced in the example embodiment.

Location Recognition

In an example embodiment, a Nearest Neighbour Matching method is used to calculate a number of matches for each location, hence identifying the location. Given a query image, features are extracted and the distance is calculated between each feature vector and the feature vectors representing the training images at each location.

D(i,k,l)=|f_{q}(i)−fₜ(k,l)| (15)

where D(j, k, l) is the distance between the i^{th} feature vector in the query image and the k^{th} feature vector in the training images at location l. f_{q}(i) is the i^{th} feature vector extracted on the query image. fₜ(k, l) is the k^{th} feature vector extracted on the training images captured at location l.

At each location l, a nearest matching distance is found for each feature vector f_{q}(i) in the query image in the example embodiment, i.e.:

$$\begin{matrix}{D}_{min} ( i , l ) = {Min}_{k} \{ D ( i , k , l \} \\ If & ( 16 ) \\ {D}_{min} ( i , l ) < T & ( 17 )\end{matrix}$$

then a match for the feature vector f_{q}(i) is obtained at location l in the example embodiment. Further, in the example embodiment, T is the same distance threshold used in Equation (11). All matches Mₗ for each location are summed, and the average matching distance for those distances within the threshold is calculated. The location with a larger number of matches and a smaller average distance is considered as the best matching location in the exampled embodiment. Therefore, the voting function is defined in the example embodiment as:

$$\begin{matrix}V ( l ) = {M}_{l} / \overline{D} \\ {M}_{l} > 0 & ( 18 ) \\ where \overline{D} = \frac{1}{{M}_{l}} {\sum }_{T < {D}_{min} ( i , l )} {D}_{min} ( i , l ) \\ {M}_{l} > 0 & ( 19 )\end{matrix}$$

### That is,

$$V ( l ) = {M}_{l}^{2} / {\sum }_{T < {D}_{min} ( i , l )} {D}_{min} ( i , l ) \\ {M}_{l} > 0 \qquad ( 20 )$$

In the example embodiment, the location L with maximum V(l) is identified as the best matching location for the query image, i.e.:

$$V ( L ) = {Max}_{l} \{ V ( l ) \} \\ {M}_{l} > 0 \qquad ( 21 )$$

When Mₗ=0 for all the locations, in the example embodiment, no location is considered as a match to the query image. In other words, the query image is not recognized.

In an alternative embodiment, a Nearest Neighbour Matching method is used to classify a query image (i.e. test image) into different classes of training images (i.e. sample images), hence identifying the location. First, the local features are pre-computed for all the key points selected for each class of images. For every discriminative feature in the test image (selected based on the method described above), a nearest neighbour search is conducted among all the selected features in a class of sample images. The best match is considered in the example embodiment as a pair of corresponding features between the test image and the sample images. Assuming all the discriminative features in a test image are Pₜ={p₁, p₂, . . . , pₙ}, and D_{tI}={d₁, d₂, . . . , dₙ} are the best match distances between feature pₖ (k=1, 2, . . . , n) in the test image and the discriminative features in the sample images of class I. Since the feature with higher discriminative value contributes more to the identification of the class of images, in the example embodiment, the distance dᵢ (i=1, 2, . . . , n) is weighted with 1/L_{Ii}, where L_{Ii} is the discriminative value of feature pᵢ (pᵢεP_{I}) in the sample images of class I. The distance between the test image and the sample images of the I^{th} class is computed as

$$\overline{{D}_{t 1}} = \frac{1}{n} {\sum }_{i = 1}^{n} ( \frac{1}{{L}_{li}} {d}_{i} ) \qquad ( 22 )$$

where dᵢ is the best match distance from feature pᵢ of the test image to the sample images of class I.

The test image is then assigned to the sample class which has the minimum distance with it (among all the locations, e.g. 50 locations in the prototype of the system of the example embodiment) using the following formula:

Dₘᵢₙ=Min{ D̅ₜ̅₁̅, D̅ₜ̅₂̅, . . . , D̅ₜ̅₅̅₀̅} (23)

Multiple Queries and User Verification Scheme

It will be appreciated that, in a practical application of location recognition, there may be a lot of scenery at a location and the collected sample images may be insufficient for all the distinctive objects. This may result in an incomplete location modelling. In addition, the picture which is sent to the server may be quite different from the sample images in the system of the example embodiment. In such case, the correct recognition result may not be obtained although the location where the user is taking the picture is in the list of places which the system intends to identify.

To overcome the above problem, multiple query images are used in the example embodiment to improve the correct recognition rate. A typical sample image for the best matching place is also sent back to the user for visual verification. The user can verify whether the result is correct or not, and decide if it is necessary to take more query images by visually matching the returned picture with the scenery which he/she sees at the location. With the multiple query images, the system of the example embodiment can provide a more reliable matching result by calculating the confidence level for each matching place.

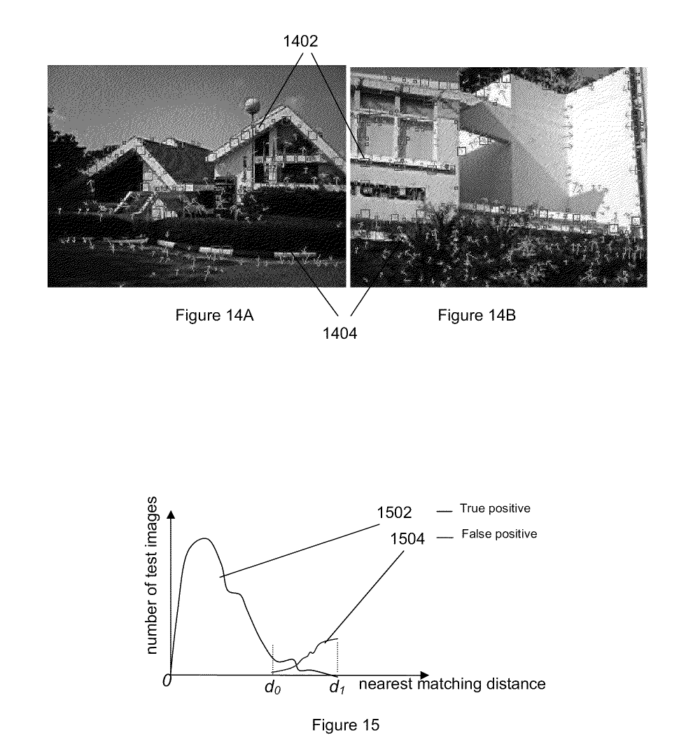

FIG. 15 shows a graph 1502 of the distribution of true positive test images against the nearest matching distance and a graph 1504 of the distribution of false positive test images against the nearest matching distance according to an example embodiment. Graphs 1502 and 1504 are obtained in the example embodiment e.g. using a validation dataset (i.e. test data labelled with ground-truth) for determining d₀ and d₁. Due to the complexity of a natural scene image, and the uncertainty of the real distance measure for high dimensional data, a calculated nearest neighbour may not be true in actual situation. In other words, a query image may not belong to its top-most matching class, but possibly belongs to the top 2 or even the top 5.

As seen from FIG. 15, not all the true positive test images have the nearest matching distance with their corresponding classes. The false positive test images may have shorter distance than the true positive ones as shown in the d₀ to d₁ region. To ensure a reliable recognition result, in the example embodiment, the nearest matching is considered correct only when the nearest distance d between the test image and its matching place is less than d₀, otherwise, the user is asked to try more query images.

From the second query, a confidence level is calculated as described below. Firstly, the top 5 matching places are computed by the system of the example embodiment for every query. Secondly, assume that from the first query to the M^{th} query, N places P={p₁, p₂, . . . , p_{N}} have appeared at the top 5 matching results. The confidence level for place pᵢ (i=1, 2, . . . , N) is defined as follows,

$${L}_{i} = \frac{1}{5 M} {\sum }_{j = 1}^{M} {R}_{ij} \\ i = 1 , 2 , … , N . \qquad ( 24 )$$

where Rᵢⱼ is a value from 1 to 5 (i.e. the value of the top 1 to top 5 matching is assigned as 5, 4, 3, 2, and 1 respectively in the example embodiment) representing the ranking of matching result for place i in the j^{th} query. For example, if in the j^{th} query, location i is at the top 2 matching position, then Rᵢⱼ=4 in the example embodiment. If location i does not appear at the top 1 to top 5 matching results, then Rᵢⱼ=0 in the example embodiment.

For every place from p₁ to p_{N} which appears at the top 5 matching result, the respective confidence level L₁ to L_{N} is calculated, and the location with maximum confidence level is returned to the user, i.e.

Lₘₐₓ=Max{L₁,L₂, . . . ,L_{N}} (25)

Based on the above, if all the M queries return location i as the top 1 matching position, the confidence level for place i reaches its maximum value, i.e. 1. In the example embodiment, if Lₘₐₓ>0.5, the result is considered reliable enough, and the user is not suggested to take more query images. However, the user can reject this result if the returned example image looks different from the scenery of the current location, and take more query images to increase the reliability while minimizing the false positive.

If Lₘₐₓ≦0.5, the location with the maximum confidence level is returned to the user in the example embodiment. The system of the example embodiment also informs the user that the result is probably wrong and prompts the user to try again by taking more query images. The user can also choose to accept the result even if Lₘₐₓ≦0.5 if the returned example image looks substantially the same as what he/she sees at the location. The above approach may ensure that the user gets a reliable result in a shorter time.

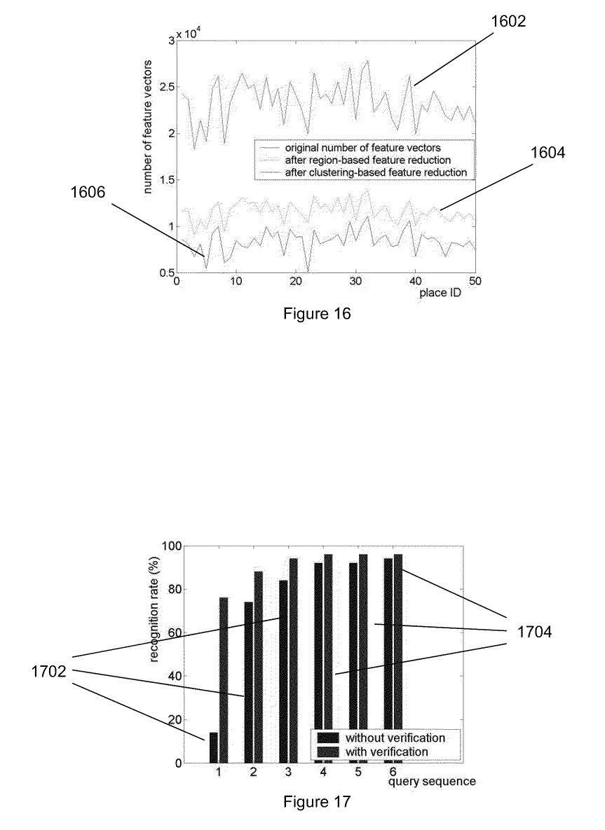

FIG. 16 shows graphs comparing the number of feature vectors before and after each reduction according to an example embodiment. Experiments have been carried out on a prototype based on the system of the example embodiment having a dataset SH comprising 50 places with 25 sample images for each place. All of these sample images are taken by high-resolution digital camera and resized to a smaller size of 320×240 pixels. The test images form a TL dataset taken by a lower-resolution mobile phone camera.

In FIG. 16, line 1602, 1604 and 1606 represent the original number of feature vectors, the number of feature vectors after a region-based feature reduction and the number of feature vectors after a clustering-based feature reduction respectively. As can be seen from FIG. 16, the original average number of SIFT feature vectors detected for each image is about 933. After the region-based feature reduction, the average number of feature vectors is reduced to about 463. With the clustering-based feature reduction, the average number of feature vectors is further reduced to about 335. The experiment result have shown that both of these feature reduction methods do not sacrifice the recognition accuracy while the number of feature vectors is reduced to about half to one third of the original one respectively.

FIG. 17 shows a chart comparing recognition rate without verification scheme and recognition rate with verification scheme according to an example embodiment. In FIG. 17, columns 1702 represent the results without the verification scheme, and columns 1704 represent the results with the verification scheme.

To evaluate the multiple queries and user verification scheme, in the example embodiment, 510 images taken from the 50 places are used to test the recognition accuracy with a single query. Using the nearest neighbour as the recognition result without a distance threshold, 75% of the query images are correctly recognized but the remaining 25% are falsely recognized. With the multiple queries and user verification scheme, the results are significantly improved in the example embodiment, as shown in FIG. 17. The recognition rate increases with the number of queries and saturates at around the fourth query. 96% of the places (48 out of 50) are recognized with maximum 4 queries and the error rate is 0%. Only 2 locations are not recognized within 6 queries. This performance is much better than the single query result.

Without user's visual verification, about 14% of the 50 locations are recognized at the first query. The low recognition rate at the first query is due to the strict distance threshold d₀ in the example embodiment to achieve low error rate. For all the 50 locations, only one is falsely recognized. With the user's visual verification of the returned image, the recognition rate increases significant at the first, second and third query. The falsely recognized location is also corrected with more queries. One of the unrecognized locations with confidence level of 0.45 is accepted by the user after visual matching of the returned image with the scenery of the place where he/she is.

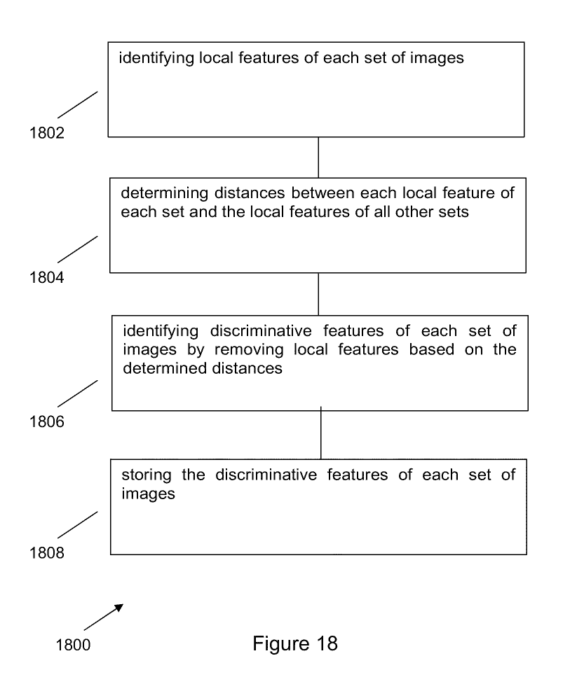

FIG. 18 shows a flowchart 1800 illustrating a method of maintaining a database of reference images, the database including a plurality of sets of images, each set associated with one location or object. At step 1802, local features of each set of images are identified. At step 1804, distances between each local feature of each set and the local features of all other sets are determined. At step 1806, discriminative features of each set of images are identified by removing local features based on the determined distances. At step 1808, the discriminative features of each set of images are stored.

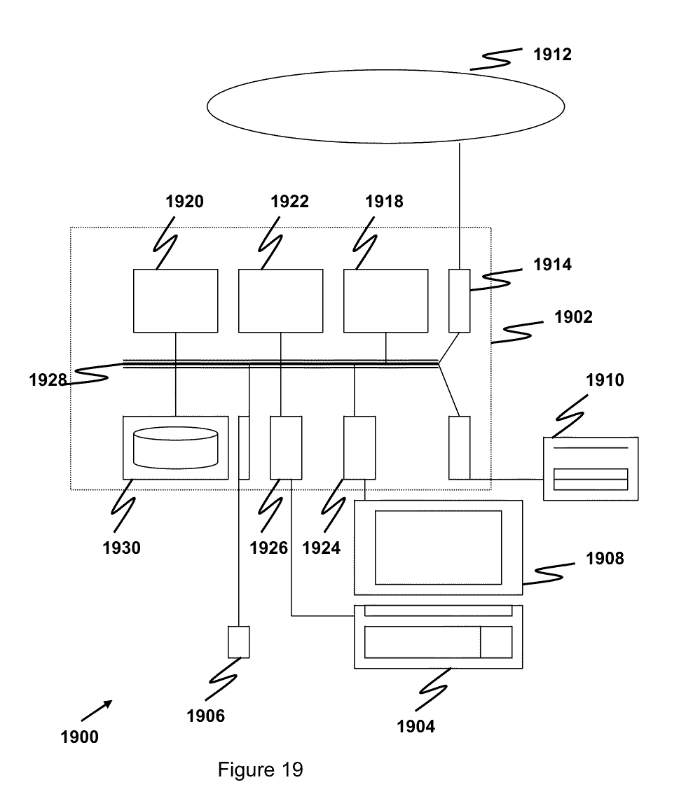

The method and system of the example embodiment can be implemented on a computer system 1900, schematically shown in FIG. 19. It may be implemented as software, such as a computer program being executed within the computer system 1900, and instructing the computer system 1900 to conduct the method of the example embodiment.

The computer system 1900 comprises a computer module 1902, input modules such as a keyboard 1904 and mouse 1906 and a plurality of output devices such as a display 1908, and printer 1910.

The computer module 1902 is connected to a computer network 1912 via a suitable transceiver device 1914, to enable access to e.g. the Internet or other network systems such as Local Area Network (LAN) or Wide Area Network (WAN).

The computer module 1902 in the example includes a processor 1918, a Random Access Memory (RAM) 1920 and a Read Only Memory (ROM) 1922. The computer module 1902 also includes a number of Input/Output (I/O) interfaces, for example I/O interface 1924 to the display 1908, and I/O interface 1926 to the keyboard 1904.

The components of the computer module 1902 typically communicate via an interconnected bus 1928 and in a manner known to the person skilled in the relevant art.

The application program is typically supplied to the user of the computer system 1900 encoded on a data storage medium such as a CD-ROM or flash memory carrier and read utilising a corresponding data storage medium drive of a data storage device 1930. The application program is read and controlled in its execution by the processor 1918. Intermediate storage of program data maybe accomplished using RAM 1920.

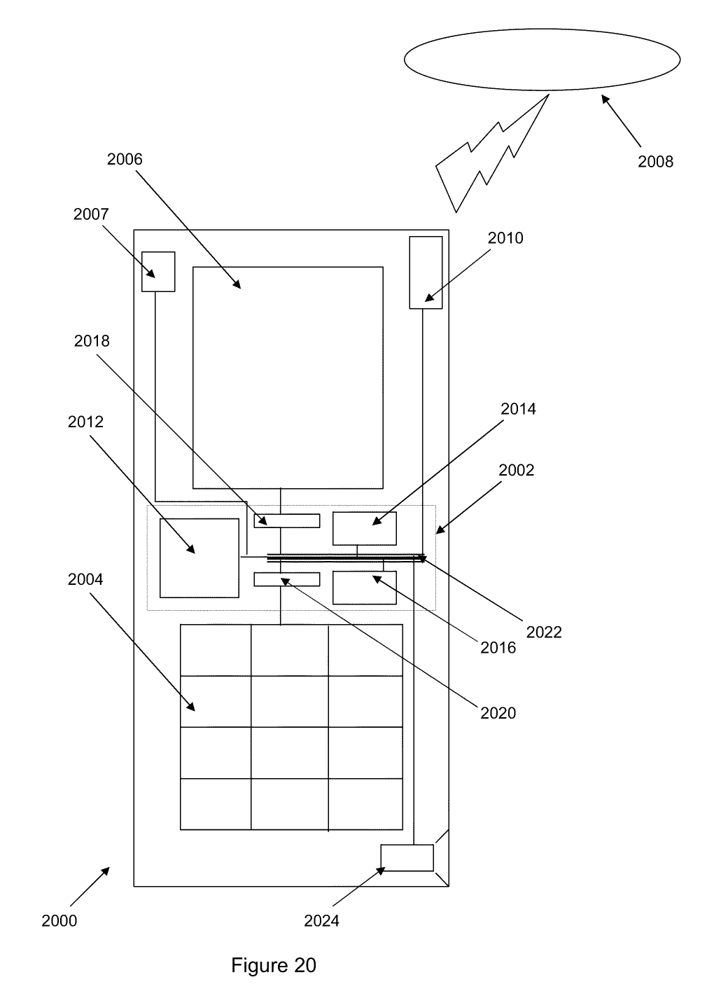

The method of the current arrangement can be implemented on a wireless device 2000, schematically shown in FIG. 20. It may be implemented as software, such as a computer program being executed within the wireless device 2000, and instructing the wireless device 2000 to conduct the method.

The wireless device 2000 comprises a processor module 2002, an input module such as a keypad 2004, an output module such as a display 2006 and a camera module 2007. The camera module 2007 comprises an image sensor, e.g. a Charge-Coupled Device (CCD) image sensor or a Complementary Metal Oxide Semiconductor (CMOS) image sensor, capable of taking still images.

The processor module 2002 is connected to a wireless network 2008 via a suitable transceiver device 2010, to enable wireless communication and/or access to e.g. the Internet or other network systems such as Global System for Mobile communication (GSM) network, Code Division Multiple Access (CDMA) network, Local Area Network (LAN), Wireless Personal Area Network (WPAN) or Wide Area Network (WAN).

The processor module 2002 in the example includes a processor 2012, a Random Access Memory (RAM) 2014 and a Read Only Memory (ROM) 2016. The processor module 2002 also includes a number of Input/Output (I/O) interfaces, for example I/O interface 2018 to the display 2006, and I/O interface 2020 to the keypad 2004.

The components of the processor module 2002 typically communicate via an interconnected bus 2022 and in a manner known to the person skilled in the relevant art.

The application program is typically supplied to the user of the wireless device 2000 encoded on a data storage medium such as a flash memory module or memory card/stick and read utilising a corresponding memory reader-writer of a data storage device 2024. The application program is read and controlled in its execution by the processor 2012. Intermediate storage of program data may be accomplished using RAM 2014.

The method and system of the example embodiment can be used to provide useful local information to tourists and local users who are not familiar with the place they are currently visiting. Users can get information about the current place at the time when they are around the place without any planning. They can also upload the photos taken some time ago to get information about the place where the photos are taken when they are reviewing the photos at any time and anywhere.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method of maintaining a database of reference images, the database including a plurality of sets of images, each set associated with one location or object; the method comprising the steps of:
identifying local features of each set of images;
determining distances between each local feature of each set and the local features of all other sets;
identifying discriminative features of each set of images by removing local features based on the determined distances; and
storing the discriminative features of each set of images.

2. The method as claimed in claim 1, wherein identifying the local features comprises:
identifying key points; and
extracting features from the key points.

3. The method as claimed in claim 2, further comprising reducing a number of key points prior to extracting the features.

4. The method as claimed in claim 3, wherein reducing the number of key points comprises a region-based key point reduction.

5. The method as claimed in claim 4, wherein the region-based key point reduction comprises choosing one of the key points in a region having a highest radius.

6. The method as claimed in claim 2, further comprising reducing a number of extracted features.

7. The method as claimed in claim 6, wherein reducing the number of extracted features comprises a hierarchical feature clustering.

8. The method as claimed in claim 1, wherein removing local features based on the determined distances comprises removing the local features having distances to any local feature of the other sets lower than a first threshold.

9. The method as claimed in claim 1, wherein removing local features based on the determined distances comprises:
calculating respective discriminative values for each local feature of said set based on the determined distances; and
removing the local features having discriminative values lower than a second threshold.

10. A method for image based mobile information retrieval, the method comprising the steps of:
maintaining a dedicated database of reference images as claimed in claim 1;
taking a query image of a location or object by a user using a mobile device;
transmitting the query image to a information server;
comparing the image with reference images in the dedicated database coupled to the information server;
identifying the location or object based on a matched reference image; and
transmitting information based on the identified location or object to the user.

11. The method as claimed in claim 10, wherein comparing the image with reference images comprises a nearest neighbour matching.

12. The method as claimed in claim 11, wherein nearest neighbour matching comprises:
determining a minimum distance between each feature vector of the query image and feature vectors of reference images of each location or object; and
calculating a number of matches for each location or object, wherein a match comprises the minimum distance being smaller than a third threshold.

13. The method as claimed in claim 12, wherein the third threshold is equal to the first threshold.

14. The method as claimed in claim 12, further comprising calculating a vote based on the number of matches and an average matching distance, wherein the highest vote comprises the nearest neighbour.

15. The method as claimed in claim 10, wherein the identifying of the location or object comprises a multi query user verification.

16. The method as claimed in claim 15, further comprising transmitting a sample photo of the identified location or object to the user.

17. The method as claimed in claim 15, wherein the multi query user verification comprises taking a new query image of the location or object by the user using the mobile device and transmitting the new query image to an information server.

18. The method as claimed in claim 17, further comprising calculating a confidence level of the identified location or object based on results of one or more previous query images and the new query image.

19. The method as claimed in claim 18, further comprising transmitting a new query image recommendation to the user if the confidence level of the identified location or object is below a fourth threshold.

20. A system for maintaining a database of reference images, the database including a plurality of sets of images, each set associated with one location or object; the system comprising:
means for identifying local features of each set of images;
means for determining distances between each local feature of each set and the local features of all other sets;
means for identifying discriminative features of each set of images by removing local features based on the determined distances; and
means for storing the discriminative features of each set of images.

21. The system as claimed in claim 20, wherein the means for identifying the discriminative features removes the local features having distances to any local feature of the other sets lower than a first threshold.

22. The system as claimed in claim 20, wherein the means for identifying the discriminative features calculates respective discriminative values for each local feature of said set based on the determined distances, and removes the local features having discriminative values lower than a second threshold.

23. A data storage medium comprising code means for instructing a computing device to exercise a method of maintaining a database of reference images, the database including a plurality of sets of images, each set associated with one location or object; the method comprising the steps of:
identifying local features of each set of images;
determining distances between each local feature of each set and the local features of all other sets;
identifying discriminative features of each set of images by removing local features based on the determined distances; and
storing the discriminative features of each set of images.

24. A system for image based mobile information retrieval, the system comprising:
means for maintaining a dedicated database of reference images as claimed in claim 1;
means for receiving a query image of a location or object taken by a user using a mobile device;
means for comparing the image with reference images in the dedicated database;
means for identifying the location or object based on a matched reference image; and
means for transmitting information based on the identified location or object to the user.

25. A data storage medium comprising code means for instructing a computing device to exercise a method for image based mobile information retrieval, the method comprising the steps of:
receiving a query image of a location or object taken by a user using a mobile device;
comparing the image with reference images in the dedicated database;
identifying the location or object based on a matched reference image; and
transmitting information based on the identified location or object to the user.
